(19) United States
(12) Patent Application Publication
(10) Pub. No.: US 2020/0074209 A1
(43) Pub. Date: Mar. 5, 2020

(54) OBJECT RECOGNITION DEVICE

(71) Applicant: DENSO CORPORATION, Kariya-city (JP)

(72) Inventors: Takuya MIWA, Kariya-city (JP); Kenji OKANO, Kariya-city (JP)

(21) Appl. No.: 16/553,631

(22) Filed: Aug. 28, 2019

(30) Foreign Application Priority Data
Aug. 30, 2018 (JP) 2018-161454

(51) Int. Cl. G06K 9/32; G06F 16/583; G06T 15/60; G06K 9/00

(52) U.S. Cl. CPC G06K 9/3241; G06K 9/00805; G06T 15/60; G06F 16/583

(57) ABSTRACT

In an object recognition device, an object recognition unit is configured to acquire a captured image and recognize an object in the acquired captured image. In the object recognition device, a shadow detection unit is configured to determine whether a shadow of the object is present in the acquired captured image, and an output unit is configured to output a determination result based on whether a shadow of the object is present.

### CROSS-REFERENCE TO RELATED APPLICATION

This application is based on and claims the benefit of priority from earlier Japanese Patent Application No. 2018-161454 filed Aug. 30, 2018, the description of which is incorporated herein by reference.

### BACKGROUND

### Technical Field

The present disclosure relates to an object recognition device configured to recognize an object in a captured image.

### Related Art

A technique for recognizing an object by image processing of a captured image has been widely known.

### BRIEF DESCRIPTION OF THE DRAWINGS

In the accompanying drawings:

FIG. 1 is a block diagram showing a configuration of a vehicle control system 1;

FIG. 2 is a flow chart of an object recognition process;

FIG. 3 is an image view showing an example of a detection frame region and a shadow determination region;

FIG. 4 is a flow chart of a shadow detection process;

FIG. 5 shows an example of a luminance histogram for a detection frame region in which no shadow is present;

FIG. 6 shows an example of a luminance histogram for a detection frame region in which a shadow is present;

FIG. 7 shows an example of a feature vector for the detection frame region in which no shadow is present;

FIG. 8 shows an example of a feature vector for the detection frame region in which a shadow is present;

FIG. 9 is a flow chart of a correction-evaluation process of a first embodiment;

FIG. 10 shows an example of a luminance histogram for a luminance determination region and a luminance histogram for a shadow determination region;

FIG. 11 is an image view showing a setting example of the luminance determination region;

FIG. 12 is a flow chart of a correction-evaluation process of a second embodiment; and

FIG. 13 is a flow chart of a correction-evaluation process of another embodiment.

### DESCRIPTION OF SPECIFIC EMBODIMENTS

When an object is recognized in a captured image, a shadow of the object may be present around the object. If the shadow is recognized as a part of the object, the shadow, which has an amorphous shape, may reduce object recognition accuracy. For example, when the object is recognized by using pattern matching, the amorphous shape of the shadow may adversely affect determination by pattern matching. Furthermore, as disclosed in JP-A-2008-097126, when the object is recognized by using an optical flow, the presence of an optical flow of the shadow unnecessary for the recognition may adversely affect determination using the optical flow.

As a result of detailed studies, the inventor has found a problem in which a reduction in object recognition accuracy may adversely affect control using an object recognition result, for example, vehicle control such as automatic driving or automatic braking.

In view of the above, it is desired to have an object recognition device for recognizing an object in a captured image, which can prevent an adverse effect on control using an object recognition result.

Hereinafter, exemplary embodiments of the present disclosure will be described in detail with reference to the accompanying drawings, in which like reference numerals refer to like or similar elements regardless of reference numerals and duplicated description thereof will be omitted.

### 1. First Embodiment

1-1. Configuration

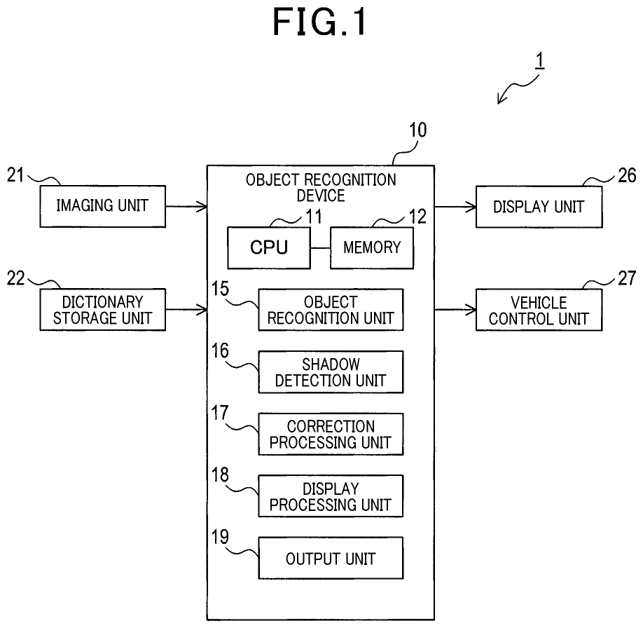

A vehicle control system 1 is, for example, a system that is mounted on a vehicle such as a passenger car or a bus and that has a function of controlling a traveling state of the vehicle. The vehicle equipped with the vehicle control system 1 is also referred to as own vehicle. As shown in FIG. 1, the vehicle control system 1 includes an object recognition device 10. Furthermore, the vehicle control system 1 may include an imaging unit 21, a dictionary storage unit 22, a display unit 26, and a vehicle control unit 27.

The imaging unit 21 is a well-known camera that captures an image of an area in a direction of travel of the own vehicle. The imaging unit 21 transmits, to the object recognition device 10, a captured image of an area around the own vehicle such as an area in the direction of travel of the own vehicle.

The dictionary storage unit 22 is a storage device that stores shadow reference data for determining whether a shadow is present.

The shadow reference data is data that serves as a dictionary including a feature of a shadow region in the captured image prepared in advance as a reference vector. The shadow reference data is used as a reference for comparison when the object recognition device 10 recognizes whether a shadow is present. The reference vector is a vector that is based on a histogram representing a shadow region and used as a reference for comparison and that has the same dimension as a feature vector (described later).

The display unit 26 is configured as a well-known display. The display unit 26 displays an image according to instructions from the object recognition device 10.

The vehicle control unit 27 is a well-known device that controls a traveling state of the own vehicle. For example, the vehicle control unit 27 is configured as an automatic brake that performs braking of the own vehicle according to a position of an object around the own vehicle. The vehicle control unit 27 is a device that uses or does not use an object recognition result depending on an evaluation value.

More specifically, when the evaluation value is lower than a preset threshold, in order to prevent malfunction, the vehicle control unit 27 is set so that an object recognition result may be not used. The evaluation value is a value representing, as a numerical value, probability of at least one of a type, a position, a moving speed, and the like of an object recognized by the object recognition device 10. In particular, in the present embodiment, the evaluation value is a value representing accuracy of the position as a numerical value.

The object recognition device 10 includes a microcomputer including a CPU 11, and for example, a semiconductor memory (hereinafter referred to as a memory 12) such as a RAM or a ROM. Functions of the object recognition device 10 are implemented when the CPU 11 executes programs stored in a non-transitory tangible storage medium. In this example, the memory 12 corresponds to the non-transitory tangible storage medium storing the programs. When one of the programs is executed, a method corresponding the program is performed. The non-transitory tangible storage medium means that an electromagnetic wave as storage media is excluded. The object recognition device 10 may include a single microcomputer or a plurality of microcomputers.

The object recognition device 10 includes an object recognition unit 15, a shadow detection unit 16, a correction processing unit 17, a display processing unit 18, and an output unit 19. A method of implementing functions of the components of the object recognition device 10 is not limited to software, and some or all of the functions may be implemented by one or more pieces of hardware. For example, when the function is implemented by an electronic circuit which is hardware, the electronic circuit may be implemented by a digital circuit, an analog circuit, or a combination thereof.

As a function of the object recognition unit 15, an object recognition process (described later) is performed.

As a function of the shadow detection unit 16, a shadow detection process (described later) is performed.

As a function of the correction processing unit 17, a correction-evaluation process (described later) is performed. In the correction-evaluation process, a detection frame region 51 is changed according to a degree of presence of the shadow in the detection frame region 51, and an evaluation value is set to a lower value.

As a function of the display processing unit 18, an image is displayed by the display unit 26. For example, as the function of the display processing unit 18, for an object recognized in the object recognition process, an icon prepared in advance according to a type of the object is displayed by the display unit 26.

As a function of the output unit 19, object information on an object recognized in the object recognition process and an evaluation value for the object calculated in the correction-evaluation process are outputted to the vehicle control unit 27.

1-2. Processes

1-2-1. Object Recognition Process

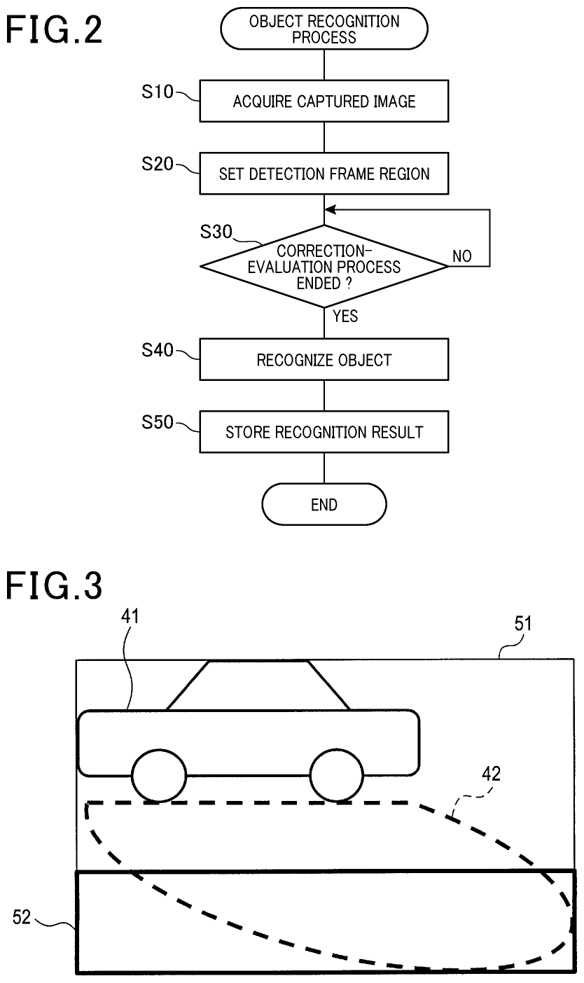

Next, the object recognition process performed by the object recognition device 10 will be described with reference to a flow chart in FIG. 2. The object recognition process is, for example, a process repeatedly performed for each preset cycle such as every 50 ms. In the object recognition process, an object is recognized in a captured image by image processing of the captured image. The recognition of an object indicates recognition of object information including a type of the object, a size of the object, a position of the object, and a moving speed of the object. The object information only needs to include at least one of the type of the object, the size of the object, the position of the object, the moving speed of the object, and the like.

In the object recognition process, first, at step S10, the object recognition device 10 acquires a captured image from the imaging unit 21. Subsequently, at step S20, the object recognition device 10 sets the detection frame region 51 in the captured image. The detection frame region 51 is a region in the captured image in which an object is to be recognized.

For example, as shown in FIG. 3, the detection frame region 51 includes an object region 41 which is a region including an object to be detected whose image has been captured. When a shadow of the object is present, the detection frame region 51 includes a shadow region 42 which is a region of the shadow of the object. The object region 41 and the shadow region 42 are integrally recognized by a detection method using a well-known optical flow. In the detection method using an optical flow, for example, a plurality of feature points in captured images for 10 frames are chronologically tracked, and feature points moving in the same direction are recognized as a plurality of feature points indicating a single object. A circumscribed rectangle circumscribed around the plurality of feature points indicating the single object is set as the detection frame region 51.

The detection frame region 51 may be recognized by using an edge region. In this case, the object region 41 and the shadow region 42 are integrally recognized as a single edge region, and a circumscribed rectangle circumscribed around the edge region including the object region 41 and the shadow region 42 is set as the detection frame region 51. The edge indicates a portion at which a difference in luminance value between adjacent pixels is a preset value or more, and the edge region indicates a region surrounded by a plurality of continuous edges.

The present embodiment describes a situation where the captured image includes a single object, i.e., an example in which a single detection frame region 51 is set in the captured image. However, the captured image may include a plurality of objects. In this case, it is only necessary to set a plurality of detection frame regions 51 for a respective plurality of feature points moving in the same direction or for respective edge regions.

An image of the detection frame region 51 is temporarily stored in the memory 12 together with a coordinate value in the captured image of the detection frame 51. For example, the memory 12 stores images of the detection frame region 51 for the latest 10 frames.

Subsequently, at step S30, the object recognition device 10 waits until the correction-evaluation process (described later) ends. Thus, the object recognition device 10 determines whether the correction-evaluation process has ended. When the object recognition device 10 determines at step S30 that the correction-evaluation process has not ended, control returns to step S30. When the object recognition device 10 determines at step S30 that the correction-evaluation process has ended, control proceeds to step S40, and the object recognition device 10 recognizes the object in the detection frame region 51.

The detection frame region 51 before being subjected to the correction-evaluation process (described later) includes the object region 41 and the shadow region 42, and thus the object is recognized in the detection frame region 51 including the shadow region 42. When the detection frame region 51 has been corrected in the correction-evaluation process (described later), however, the object is recognized in the detection frame region 51 from which the shadow region 42 has been removed.

An object recognition method using a well-known optical flow is employed to recognize the object. In the object recognition method using an optical flow, for example, a type of the object is specified by comparing a distribution of a flow of a plurality of feature points indicating a single object with object reference data for each object prepared in advance. The object reference data used to recognize the object is, for example, data that serves as a dictionary prepared for each type of the object such as a passenger car, a bus, a truck, a pedestrian, a bicycle, or a motorcycle. The object reference data is used as a reference for comparison when the object recognition device 10 recognizes the object. In the present embodiment, the object reference data on an optical flow for each type of the object is prepared in the memory 12 or another database.

In this process, a distance to the object is recognized on the basis of a coordinate value of a lower end of the detection frame region 51. Furthermore, in the object recognition method using an optical flow, a relative moving speed of the object with respect to the own vehicle can also be recognized. Instead of the object recognition method using an optical flow, for example, an object recognition method using any image processing such as an object recognition method using pattern matching may be employed.

Subsequently, at step S50, the object recognition device 10 stores an object recognition result. The object recognition result includes object information and an evaluation value set in the correction-evaluation process. After the process at step S50, the object recognition process in FIG. 2 ends.

1-2-2. Shadow Detection Process

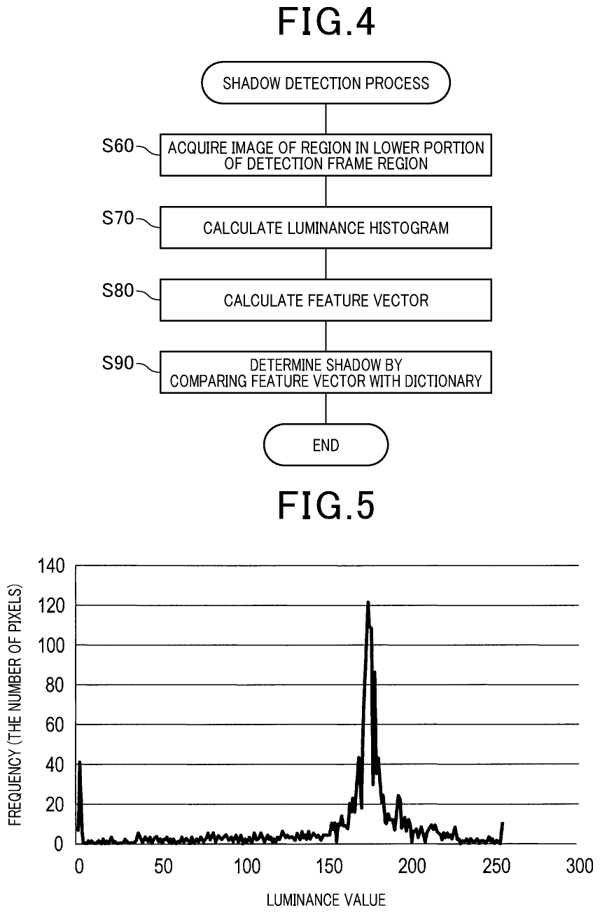

Next, the shadow detection process performed by the object recognition device 10 will be described with reference to a flow chart in FIG. 4. The shadow detection process is, for example, a process repeatedly performed for each preset cycle such as every 50 ms in parallel with other processes such as the object recognition process. The shadow detection process is a process of determining whether a shadow region is present in the detection frame region 51.

In the shadow detection process, first, at step S60, the object recognition device 10 acquires an image of a shadow determination region 52. As shown in FIG. 3, at least one shadow determination region 52 is set in a lower portion of the detection frame region 51, i.e., in a region below a center in an up down direction of the detection frame region 51. At this time, the shadow determination region 52 is set to be a region in the lower portion of the detection frame region 51 having a length, from the lower end of the detection frame region 51, of 20% of a length in the vertical or up down direction of the detection frame region 51.

Subsequently, at step S70, the object recognition device 10 calculates a luminance histogram. In this process, luminance values of a plurality of pixels included in the shadow determination region 52 are obtained and the number of pixels for each luminance value is counted, and then a luminance histogram is generated in which the number of counted pixels for each luminance value is represented as frequency. Thus, the frequency is the number of pixels having a specific luminance value in the shadow determination region 52. The luminance histogram shows a relationship between the luminance value and the frequency.

Subsequently, at step S80, the object recognition device 10 calculates a feature vector. The feature vector is a multidimensional value obtained by associating a value based on the luminance value with the frequency. The present embodiment employs a vector, but a tensor which is more multidimensional than the vector may be employed.

In this process, the feature vector is generated by multiplying the numbers of counted pixels for the respective luminance values constituting the luminance histogram. In other words, a series of values obtained by sequentially multiplying the frequencies of the luminance values constituting the luminance histogram is generated as the feature vector. More specifically, the product of frequency of a luminance value of 0, which is a base frequency in the luminance histogram, and frequency of a luminance value of 0 is set as a zeroth frequency, the product of frequency of a luminance value of 0 and frequency of a luminance value of 1 is set as a first frequency, and the product of frequency of a luminance value of 0 and frequency of a luminance value of 2 is set as a second frequency.

Thus, when an n-th frequency, which is the product of frequency of a luminance value of 0 and frequency of a maximum luminance value N such as 255, is obtained, the base luminance value is incremented from 0 to 1, and similarly, the product of frequency of a luminance value of 1 and frequency of another luminance value is sequentially calculated. When this procedure is repeated until the base luminance value reaches the maximum value N and the products of all combinations of frequencies are obtained, the generation of the feature vector of the present embodiment is completed. When the feature vector is generated, in a calculation order in which the frequencies of the luminance values are multiplied, the frequency obtained as a calculation result is associated with a “combination number” which is a serial number. In the present embodiment, a combination number 0, which is a minimum value, is associated with the product of frequency of a luminance value of 0 and frequency of a luminance value of 0, and a combination number N², which is a maximum value, is associated with the product of frequency of a luminance value of N and frequency of a luminance value of N.

For example, a value of the product of frequency of a luminance value of 0 and frequency of a luminance value of 1 overlaps a value of the product of frequency of a luminance value of 1 and frequency of a luminance value of 0, but the present embodiment allows such overlapping. However, the object recognition device 10 may be configured not to perform overlapping calculation or configured to remove a calculation result obtained by overlapping calculation.

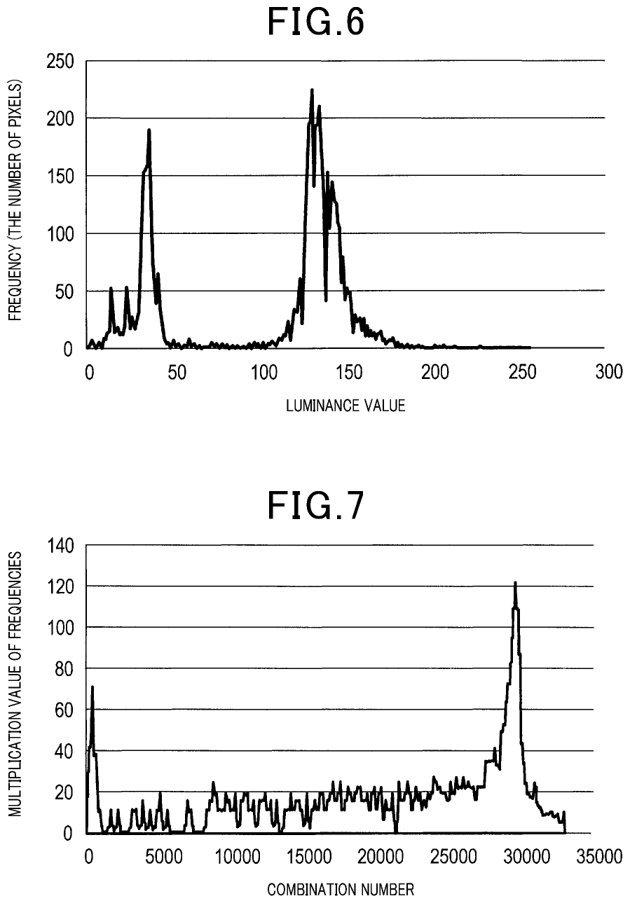

A luminance histogram shown in FIG. 5 for a case where the shadow region 42 is not present in the detection frame region 51 is compared with a luminance histogram shown in FIG. 6 for a case where the shadow region 42 is present in the detection frame region 51. As shown in FIG. 6, when the shadow region 42 is present, a peak of frequency is detected in a region in which the luminance value is relatively low. As shown in FIG. 5, however, when the shadow region 42 is not present, the frequency is also high in a region in which the luminance value is close to 0. Thus, in some cases, it is difficult to determine, by simply comparing luminance histograms, whether a shadow is present.

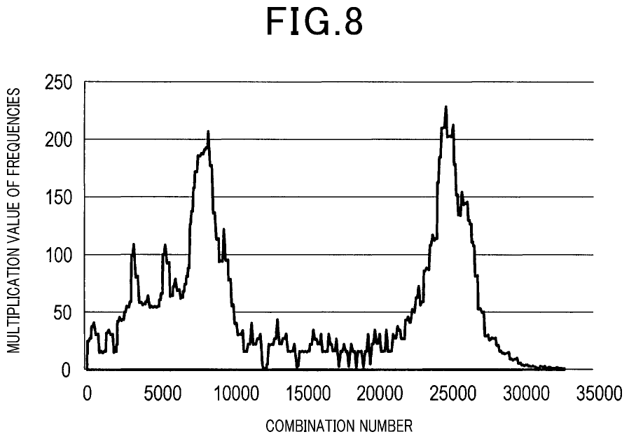

Feature vectors obtained in the process at step S80 for these luminance histograms show a significant difference depending on whether a shadow is present. For example, in a feature vector shown in FIG. 7 for the detection frame region in which no shadow is present, when the combination number, which is a value on a lateral axis, is close to 30000, the frequency reaches a peak and has a value of approximately 120, which is relatively low. On the other hand, in a feature vector shown in FIG. 8 for the detection frame region in which a shadow is present, the frequency reaches two peaks: when the combination number is close to 10000 and when the combination number is close to 25000. A value of the frequency at these peaks is approximately 200, and accordingly relatively large peaks are obtained. Thus, in the feature vector obtained in the process at step S80, when a shadow is present, two large peaks of the frequency are present in a region indicating a shadow region and having a low luminance value and a region indicating a road surface region. On the other hand, when no shadow is present, no large peak is present, or even if a large peak is present, only a single peak tends to be present. This result shows that the feature vector of the present embodiment is less likely to cause erroneous determination of whether a shadow is present and makes it possible to accurately determine whether a shadow is present.

Subsequently, at step S90, by comparing the feature vector with the reference vector, the object recognition device 10 determines whether a shadow is present. As the reference vector, at least a distinctive vector when the shadow region 42 is present in the shadow determination region 52 is prepared. According to a degree of similarity between the feature vector and the reference vector, for example, a degree of matching of positions of peaks, frequencies at the positions of the peaks, or the like, it is determined whether a shadow is present. A determination result obtained in this process is stored in the memory 12.

After such a process, the shadow detection process in FIG. 4 ends.

1-2-3. Correction-Evaluation Process

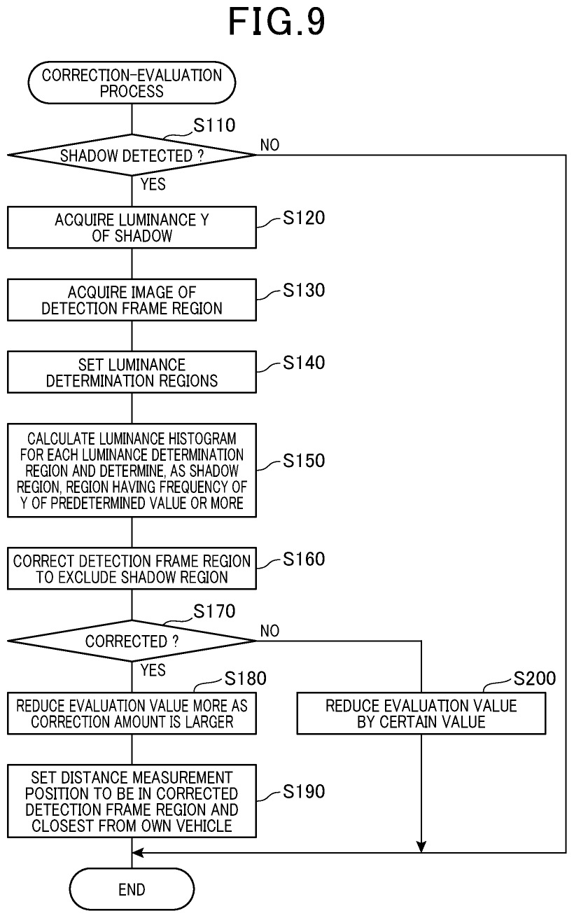

The correction-evaluation process performed by the object recognition device 10 will be described with reference to a flow chart in FIG. 9. The correction-evaluation process is, for example, a process repeatedly performed for each preset cycle such as every 50 ms in parallel with other processes such as the object recognition process.

In the correction-evaluation process, first, at step S110, the object recognition device 10 determines whether a shadow has been detected in the shadow detection process. When the object recognition device 10 determines at step S110 that no shadow has been detected, the correction-evaluation process in FIG. 9 ends.

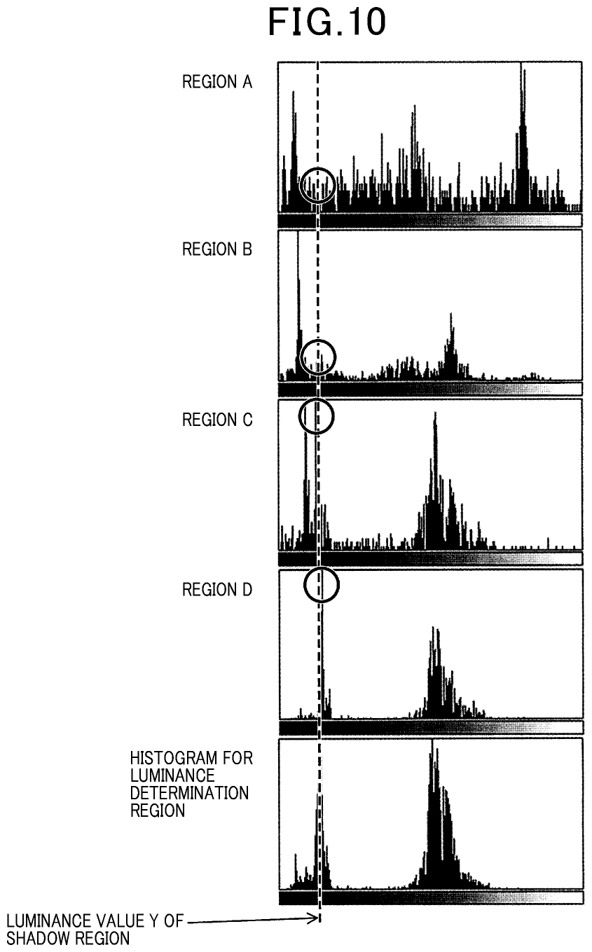

On the other hand, when the object recognition device 10 determines at step S110 that a shadow has been detected, control proceeds to step S120, and the object recognition device 10 acquires a luminance value Y of the shadow. As shown at the bottom of FIG. 10, the luminance value Y of the shadow indicates, in a luminance histogram for the shadow determination region 52 determined to include the shadow, a luminance value with highest frequency in a preset range of luminance values of the shadow, for example, a range of luminance values from 0 to approximately 20%.

Subsequently, at step S130, the object recognition device 10 acquires an image of the detection frame region 51. Subsequently, at step S140, the object recognition device 10 sets a plurality of luminance determination regions 53.

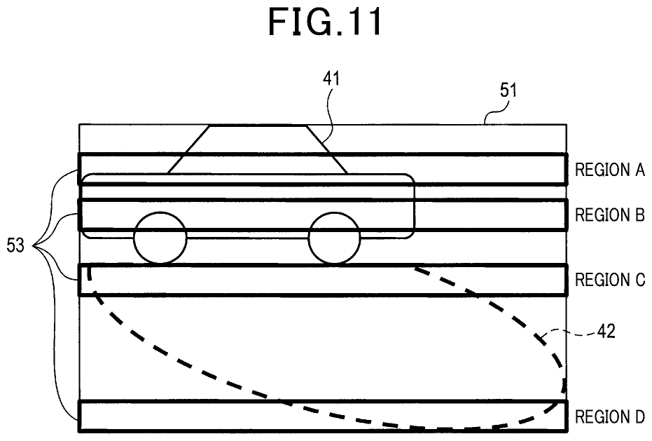

As shown in FIG. 11, the object recognition device 10 sets the luminance determination regions 53 having a ribbon shape at four arbitrary portions in the detection frame region 51 so that the luminance determination regions 53 are not adjacent to each other and that the luminance determination regions 53 each include all pixels in a horizontal direction in the detection frame region 51. The luminance determination regions 53 are set so that a plurality of pixels in the up down direction of the detection frame region 51 are included.

Subsequently, at step S150, the object recognition device 10 calculates a luminance histogram for each of the plurality of luminance determination regions 53, and determines, as a shadow region, a region in which a frequency of the luminance value Y is a predetermined value or more. For example, the predetermined value is set to approximately 80% of the frequency of the luminance value Y. FIG. 11 shows an example of a luminance histogram for the plurality of luminance determination regions 53 set in FIG. 10, which are a region A, a region B, a region C, and a region D in order from the top.

In the example shown in FIG. 11, the frequency of the luminance value Y exceeds the predetermined value in the region C and the region D, and these regions are set as the shadow region.

Subsequently, at step S160, the object recognition device 10 corrects the detection frame region 51 so that the shadow region is excluded. In other words, as a determination result based on whether a shadow of the object is present, the object recognition device 10 performs output for correcting the detection frame region 51. Thus, in the example shown in FIG. 11, a region from an upper end of the detection frame region 51 to an upper end of the region C is the corrected detection frame region 51. When no shadow region has been set, the correction of the detection frame region 51 is omitted.

Subsequently, at step S170, the object recognition device 10 determines whether the detection frame region 51 has been corrected.

When the object recognition device 10 determines at step S170 that the detection frame region 51 has been corrected, control proceeds to step S180, and the object recognition device 10 corrects an evaluation value according to an amount of the correction. In other words, as a determination result based on whether a shadow of the object is present, the object recognition device 10 outputs the evaluation value. Specifically, for example, the evaluation value is corrected by subtraction from a reference score set to 100 points or the like. In the present embodiment, an area of the corrected detection frame region 51 may be set as the evaluation value with an area of the original detection frame region 51 set in the process at step S20 taken as 100. A larger amount of correction of the detection frame region 51 causes the evaluation value to be more reduced.

Subsequently, at step S190, the object recognition device 10 sets a distance measurement position to be located in the corrected detection frame region 51 and closest from the own vehicle. A distance from the own vehicle when the object is present at a position of each pixel constituting the captured image is associated in advance with each pixel according to a coordinate value of each pixel. Thus, from the pixels in the detection frame region 51, the object recognition device 10 selects a pixel associated with a closest distance from the own vehicle, and sets a position at the distance corresponding to the pixel as the distance measurement position for the object.

On the other hand, when the object recognition device 10 determines at step S170 that the detection frame region 51 has not been corrected, control proceeds to step S200, and the evaluation value is reduced by a preset predetermined value, for example, by approximately 1 percent. This process is performed when a shadow has been detected in the above-described shadow detection process but no shadow has been detected in the correction-evaluation process. In this case, it is estimated that the shadow has a minor effect on object recognition, and thus the evaluation value is less reduced than when the detection frame region 51 has been corrected.

When the process at step S190 or S200 ends, the correction-evaluation process in FIG. 9 ends.

1-3. Effects

The first embodiment described above in detail yields the following effects.

(1a) An aspect of the present disclosure is the vehicle control system 1, and the object recognition device 10 is configured to acquire a captured image and to recognize an object in the acquired captured image. Furthermore, the object recognition device 10 is configured to determine whether a shadow of the object is present and to output a determination result based on whether a shadow of the object is present.

According to the above configuration, since the object recognition device 10 outputs the determination result of whether a shadow of the object to be recognized is present in the captured image, object recognition accuracy can be notified. Furthermore, when the object includes a region of the shadow, the region of the shadow is removed and the object is recognized again. Accordingly, the object can be accurately recognized. Thus, it is possible to prevent an adversely effect on control using an object recognition result.

(1b) The object recognition device 10 is configured to output, as the determination result, the evaluation value indicating object recognition accuracy, and the object recognition result.

According to the above configuration, since the evaluation value indicating object recognition accuracy and the object recognition result are outputted, it becomes easier for a device that uses the object recognition result to determine by using the evaluation value whether to use the object recognition result.

(1c) The object recognition device 10 is configured such that when a shadow of the object is present, the object recognition device 10 recognizes the object in a region in the captured image from which a region of the shadow has been removed.

According to the above configuration, since, when a shadow of the object is present, the object is recognized in the region from which the region of the shadow has been removed, it is possible to prevent an adverse effect of the shadow.

(1d) The object recognition device 10 is configured to set at least one shadow determination region 52 including a plurality of pixels and at least one luminance determination region 53 including a plurality of pixels in a region in the captured image including the object. Furthermore, the object recognition device 10 is configured to generate a luminance histogram by obtaining luminance values of the plurality of pixels included in the shadow determination region 52 and the luminance determination region 53 and counting the number of pixels for each luminance value. Furthermore, the object recognition device 10 is configured to generate a feature vector based on the luminance histogram and to determine, by comparing the feature vector with the reference vector prepared in advance, whether a shadow of the object is present.

According to the above configuration, since by comparing the feature vector based on the luminance histogram with the reference vector prepared in advance, it is determined whether a shadow of the object is present, it is possible to determine, according to the whole luminance distribution, whether a shadow of the object is present. This makes it possible to accurately determine whether a shadow is present.

(1e) The object recognition device 10 generates the feature vector by multiplying the numbers of counted pixels for the respective luminance values constituting the histogram.

According to the above configuration, by multiplying the numbers of counted pixels for the respective luminance values constituting the histogram, the number of dimensions of the feature vector can be increased before the feature vector is compared with the reference vector. This makes it possible more accurately determine whether a shadow is present.

(1f) The object recognition device 10 is configured to set the detection frame region 51 indicating a region in the captured image in which an object is present and to recognize the object in the detection frame region 51. Furthermore, the object recognition device 10 is configured to set the at least one shadow determination region 52 and the at least one luminance determination region 53 in the lower portion of the detection frame region 51. Furthermore, the object recognition device 10 is configured such that when a shadow is present in the shadow determination region 52 and the luminance determination region 53, the object recognition device 10 removes, from the detection frame region 51, the shadow determination region 52 and the luminance determination region 53 in which the shadow is present, and recognizes the object in the detection frame region 51 from which the shadow determination region 52 and the luminance determination region 53 have been removed.

According to the above configuration, since the object is recognized in the detection frame region 51 from which the shadow determination region 52 and the luminance determination region 53 in which the shadow is present have been removed, it is possible to prevent an adverse effect of the shadow during object recognition.

### 2. Second Embodiment

2-1. Differences from First Embodiment

A second embodiment is similar in basic configuration to the first embodiment, and thus differences from the first embodiment will be described below. The same reference numerals as the first embodiment indicate the same components, and the preceding description is referred to.

In the first embodiment described above, the luminance determination region 53 having a ribbon shape is set to determine the shadow region. On the other hand, the second embodiment differs from the first embodiment in that the luminance determination region 53 is set for each line to determine the shadow region.

2-2. Processes

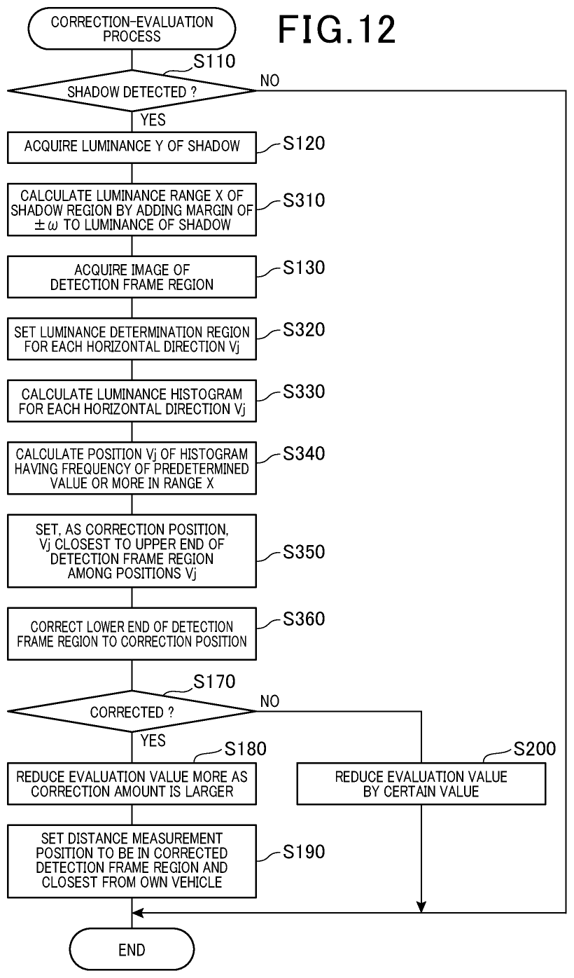

Next, a correction-evaluation process of the second embodiment performed by the object recognition device 10 of the second embodiment, instead of the correction-evaluation process of the first embodiment shown in FIG. 9, will be described with reference to a flow chart in FIG. 12. Processes at steps S110 to S130 and processes at steps S170 to S200 in FIG. 12 are similar to the processes at steps S110 to S130 and the processes at steps S170 to S200 in FIG. 9, and thus description is partially omitted.

In the correction-evaluation process of the second embodiment, between steps S120 and S130, a process at step S310 is performed. At step S310, the object recognition device 10 calculates a luminance range X of the shadow by adding a margin of ±ω to the luminance value Y of the shadow.

Subsequent to step S130, at step S320, the object recognition device 10 sets the luminance determination region 53 for each horizontal direction Vj. The horizontal direction Vj indicates, among a plurality of pixels constituting the detection frame region 51, all pixels that have the same coordinate in the up down direction and are arranged in the horizontal direction. Thus, the object recognition device 10 sets the luminance determination region 53 for each line of a plurality of pixels arranged in the horizontal direction.

Subsequently, at step S330, the object recognition device 10 calculates a luminance histogram for each horizontal direction Vj. Subsequently, at step S340, the object recognition device 10 calculates, as a shadow position Vj, a horizontal direction Vj having frequency of a predetermined value or more in the luminance range X.

In this process, the plurality of horizontal directions Vj are divided into a horizontal direction Vj that is the shadow position Vj and a horizontal direction Vj that is not the shadow position Vj. The predetermined value is set in advance by learning or experience by calculating a luminance value histogram for each line in the image including the shadow.

Subsequently, at step S350, the object recognition device 10 sets, as a correction position, a shadow position Vj closest to the upper end of the detection frame region 51 among the shadow positions Vj.

Subsequently, at step S360, the object recognition device 10 corrects a position of the lower end of the detection frame region 51 so that the lower end of the detection frame region 51 is moved upward to the correction position. Thus, the luminance determination region 53 located at the shadow position Vj is removed from the detection frame region 51. When this process ends, the correction-evaluation process in FIG. 12 ends.

2-3. Effects

The second embodiment described above in detail yields the effect (1a) of the first embodiment mentioned above and the following effect.

(2a) The object recognition device 10 is configured to set at step S320 the plurality of luminance determination regions 53 for the respective columns of pixels in the horizontal direction constituting the detection frame region 51. Furthermore, the object recognition device 10 is configured such that when a shadow is present in one or more of the plurality of luminance determination regions 53, the object recognition device 10 removes at step S360 the one or more of the plurality of luminance determination regions 53 so that the luminance determination region 53 located uppermost among the one or more of the plurality of luminance determination regions 53 is located at the lower end of the detection frame region 51, and recognizes the object in the detection frame region 51 from which the one or more of the plurality of the luminance determination regions 53 have been removed.

According to the above configuration, since the object is recognized in the detection frame region 51 from which the luminance determination region 53 in which the shadow is present has been removed, it is possible to prevent an adverse effect of the shadow during object recognition.

### 3. Modifications

The embodiments of the present disclosure have been described, but the present disclosure is not limited to the above embodiments and may be modified in various manners.

(3a) In the above embodiments, the detection frame region 51 is corrected so that the shadow region is excluded, but the present disclosure is not limited to this. For example, the object recognition device 10 may be configured not to correct the detection frame region 51 and to output an evaluation value set according to a degree of presence of the shadow.

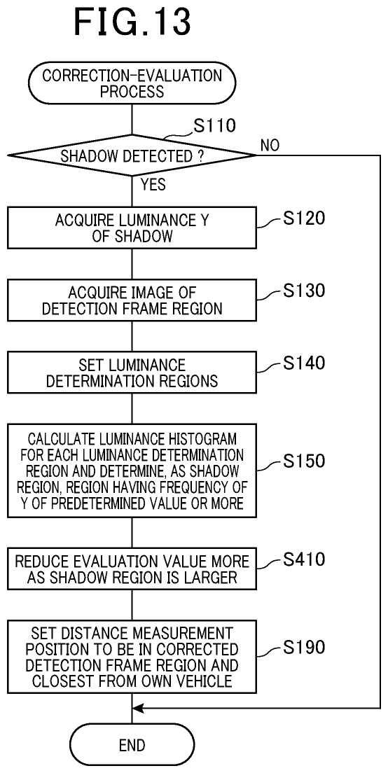

In such a case, instead of the above-described correction-evaluation processes shown in FIGS. 9 and 12, for example, a correction-evaluation process shown in FIG. 13 according to another embodiment may be performed.

In the correction-evaluation process of this embodiment, as shown in FIG. 13, from the correction-evaluation process of the first embodiment shown in FIG. 9, the processes at steps S160, S170, S180, and S200 may be omitted. Furthermore, between steps S150 and S190, the object recognition device 10 may perform a process at step S410.

In this case, the object recognition device 10 may be configured to reduce at step S410 the evaluation value more as the shadow region is larger. For example, in the example shown in FIG. 13, the detection frame region 51 is not corrected, but the evaluation value may be subtracted similarly to when the detection frame region 51 is assumed to have been corrected as in the first embodiment.

According to the above configuration, it is possible to notify a device that uses an object recognition result whether the shadow affects the object recognition result.

(3b) In the above embodiments, in the shadow detection process, the multidimensional feature vector obtained by multiplying the luminance values is used to determine whether a shadow is present, but the present disclosure is not limited to this. For example, a feature vector obtained from the luminance histogram itself may be used to determine whether a shadow is present.

(3c) In the above embodiments, in the shadow detection process, it is determined whether a shadow is present in the shadow determination region 52, and in the correction-evaluation process, a method different from the method of determining whether a shadow is present in the shadow determination region 52 is used to determine whether a shadow is present in the luminance determination region 53. In the shadow detection process and the correction-evaluation process, however, similar methods may be used to determine whether a shadow is present.

Thus, the method used in the correction-evaluation process may be employed in the shadow detection process, and the method used in the shadow detection process may be employed in the correction-evaluation process. Furthermore, the object recognition device 10 may perform at least one of the process of determining whether a shadow is present in the shadow determination region 52 and the process of determining whether a shadow is present in the luminance determination region 53.

(3d) In the above embodiments, the object recognition device 10 is configured such that when a shadow of the object is present, the detection frame region is corrected and object recognition using the corrected detection frame region is performed to correct the object recognition result, but the present disclosure is not limited to this configuration. For example, object recognition may be performed by different methods depending on whether a shadow is present.

In such a configuration, the object recognition unit 15 may be configured to set an object region (detection frame region 51), the shadow detection unit 16 may be configured to determine whether a shadow is present in the object region, and the object recognition unit may be configured to perform object recognition by different methods depending on whether a shadow is present in the object region.

As the object recognition by different methods, for example, the object recognition device 10 may be configured to perform object recognition by preparing a plurality of dictionaries for an optical flow and pattern matching and using different dictionaries depending on whether a shadow is present in the object region.

According to the above configuration, the configuration for performing object recognition can be simplified.

(3e) In the above embodiments, the shadow determination region 52 and the luminance determination region 53 are set to have a ribbon shape or set for each line. However, a region of any size, for example, a region composed of 4 pixels in length and 4 pixels in width, a region composed of only 1 pixel, or the like may be set as the shadow determination region 52 or the luminance determination region 53.

(3f) A plurality of functions of a single component in the above embodiments may be implemented by a plurality of components, or a single function of a single component may be implemented by a plurality of components. Furthermore, a plurality of functions of a plurality of components may be implemented by a single component, or a single function implemented by a plurality of components may be implemented by a single component. Furthermore, a part of the configuration of the embodiments may be omitted. Furthermore, at least a part of the configuration of the embodiments may be added to or substituted by another part of the configuration of the embodiments. Any aspect included in a technical idea specified by the wording of the claims is an embodiment of the present disclosure.

(3g) Other than the vehicle control system 1 described above, the present disclosure may also be implemented in various forms such as a device such as the object recognition device 10 which is a component of the vehicle control system 1, a program for allowing a computer to function as the vehicle control system 1, a non-transitory tangible storage medium such as a semiconductor memory in which the program is stored, and an object recognition method.

In the above embodiments, the detection frame region 51 corresponds to the object region of the present disclosure, and the shadow determination region 52 and the luminance determination region 53 correspond to a determination region of the present disclosure.

What is claimed is:

1. An object recognition device comprising:
an object recognition unit configured to acquire a captured image and recognize an object in the acquired captured image;
a shadow detection unit configured to determine whether a shadow of the object is present in the acquired captured image; and
an output unit configured to output a determination result based on whether a shadow of the object is present.

2. The object recognition device according to claim 1, wherein
the output unit outputs, as the determination result, an evaluation value indicating object recognition accuracy, and an object recognition result.

3. The object recognition device according to claim 1, wherein
when a shadow of the object is present in the captured image, the object recognition unit recognizes the object in a region in the captured image from which a region of the shadow has been removed.

4. The object recognition device according to claim 1, wherein
the shadow detection unit is configured to set at least one determination region including a plurality of pixels in a region in the captured image including the object, generate a luminance histogram by obtaining luminance values of the plurality of pixels included in the determination region and counting the number of pixels for each luminance value, and generate a feature vector based on the luminance histogram, and
the shadow detection unit is further configured to compare the feature vector with a reference vector prepared in advance and thereby determine whether a shadow of the object is present.

5. The object recognition device according to claim 4, wherein
the shadow detection unit is configured to generate the feature vector by multiplying the numbers of counted pixels for the respective luminance values constituting the luminance histogram.

6. The object recognition device according to claim 4, wherein
the object recognition unit is configured to set an object region indicating a region in the captured image in which an object is present,
the object recognition device further comprises a correction processing unit configured to correct the object region,
the shadow detection unit is configured to set the at least one determination region in a lower portion of the object region,
the correction processing unit is configured to, when a shadow is present in the determination region, correct the object region by removing, from the object region, the determination region in which the shadow is present, and
the object recognition unit is configured to recognize the object in the object region corrected by the correction processing unit.

7. The object recognition device according to claim 4, wherein
the object recognition unit is configured to set an object region indicating a region in the captured image in which an object is present,
the object recognition device further comprises a correction processing unit configured to correct the object region,
the shadow detection unit is configured to set a plurality of the determination regions for respective columns of pixels in a horizontal direction constituting the object region,
the correction processing unit is configured to, when a shadow is present in one or more of the plurality of determination regions, correct the object region by removing the one or more of the plurality of determination regions so that a determination region located uppermost among the one or more of the plurality of determination regions is located at a lower end of the object region, and
the object recognition unit is configured to recognize the object in the object region corrected by the correction processing unit.
